(19) United States
(12) Patent Application Publication
(10) Pub. No.: US 2014/0107928 A1
(43) Pub. Date: Apr. 17, 2014

(54) Evaluation of Low Resistivity Low Contrast Productive Formations

(71) Applicant: SCHLUMBERGER TECHNOLOGY CORPORATION, (US)

(72) Inventors: Indranil Roy, Sugar Land, TX (US); Richard Lewis, Frisco, TX (US); Manuel P. Marya, Sugar Land, TX (US); Partha Ganguly, Sugar Land, TX (US)

(73) Assignee: SCHLUMBERGER TECHNOLOGY CORPORATION, Sugar Land, TX (US)

(21) Appl. No.: 13/796,727

(22) Filed: Mar. 12, 2013

Related U.S. Application Data
(60) Provisional application No. 61/664,238, filed on Jun. 26, 2012.

(51) Int. Cl. G01V 3/18

(52) U.S. Cl. CPC G01V 3/18
USPC 702/7

(57) ABSTRACT

A method for identifying low resistivity low contrast high temperature high pressure productive subsurface formations rich in acid gases penetrated by a wellbore includes obtaining dielectric permittivity measurements of selected formations adjacent at least part of the wellbore. Nuclear magnetic resonance relaxometry measurements are obtained for the selected formations, the relaxometry measurements being calibrated to identify relaxation times corresponding to acid gases in high humidity at elevated pressure and temperature. Zones are identified for withdrawing formation fluid samples based on the dielectric permittivity and relaxometry measurements.

### CROSS-REFERENCE TO RELATED APPLICATION

This application claims the benefit of a related U.S. Provisional Patent Application Ser. No. 61/664,238, filed Jun. 26, 2012, entitled “EVALUATION OF LOW RESISTIVITY LOW CONTRAST PRODUCTIVE FORMATIONS,” the disclosure of which is incorporated by reference herein in its entirely.

### BACKGROUND

This disclosure relates generally to the field of identification of economically productive subsurface formations penetrated by wellbores. More specifically, the disclosure relates to the identification of formations having low electrical resistivity and low resistivity contrast and determination whether they contain economically productive fluid contents (e.g., hydrocarbons) or not (e.g., water-bearing). That is, the present disclosure relates to techniques for better distinguishing between hydrocarbon-bearing and water-bearing formations in low resistivity and low contrast formations where evaluation based on conventional resistivity measurements alone have been unable to do so.

The combination of certain well log instrument measurements, such as gamma-gamma density porosity, neutron porosity and resistivity, has proven to be very effective in the evaluation of conventional reservoirs. For low-resistivity hydrocarbon productive reservoirs, however, an accurate determination of the petrophysical parameters with such conventional instrument measurements has proven difficult. For example, using models based on the Archie water saturation equation, the Dual Water equation, Sen-Goode-Sibbit (SGS) equation, Waxman-Smith (WS) equation, and/or ELAN (a trademark of Schlumberger Technology Corporation of Sugar Land, Tex.) interpretation models may show high water saturation in certain formations, which is generally indicative of non-economically productive fluids. However, when some of these zones are tested, it has been found that water-free hydrocarbon(s) and/or wet gases may be produced, contrary to what would conventionally be expected. Thus, in the case of low resistivity contrast reservoirs, i.e., where the hydrocarbon productive formations do not exhibit much difference in electrical resistivity between them and water productive formations, it may be difficult to determine the depth position in the subsurface of a water/hydrocarbon (e.g., gas and/or oil) contact using electrical resistivity well log measurements.

As an example, major hydrocarbon accumulations have been produced in what may be termed “low resistivity, low contrast” (LRLC) sandstone formations in the Gulf of Mexico Basin (GOM). In the past, these LRLC intervals were overlooked, ignored, or misidentified as a shale or considered “wet”, i.e., saturated with enough water so as to be considered non-productive of hydrocarbons. Low resistivity hydrocarbon productive formations have been commonly defined having at most 5.0 ohm-meter resistivity. LRLC productive zones known in the art, which commonly result from thin, inter-bedded productive sandstone layers and non-productive, low resistivity shale layers can be recognized through proper identification and evaluation techniques using standard axial resolution and high axial resolution well logs, drill cuttings, sidewall cores and whole core samples and indirectly, surface reflection seismic surveys.

A number of factors have been found to act on measurements made by well logging instruments to produce low resistivity and/or low contrast, yet economically productive formations. Moore et al., “PRODUCTIVE LOW RESISTIVITY WELL LOGS OF THE OFFSHORE GULF OF MEXICO”, The New Orleans Geological Society (1993), cites the following causes:
a) Bed Thickness: some pay zones are too thin to be resolved by the logging tool;
b) Grain Size: very fine grain size can lead to high irreducible water saturation;
c) Mineralogy: conductive minerals (such as pyrite, glauconite, hematite, or graphite) or rock fragments can have a substantial effect on resistivity response, that is to cause it to be lower than would otherwise be the case if the minerals were substantially non-conductive;
d) Structural Dip: dipping beds (i.e., formation layers inclined from horizontal and/or perpendicular to the wellbore axis) produce significant excursions on the resistivity log when orientation between the tool and the bed deviates from normal;
e) Clay Distribution: classified as either dispersed, structural, or laminated, all of which are capable of holding bound water;
f) Water Salinity: high salinity interstitial water causes low resistivity within the hydrocarbon productive zone, while low salinity water can cause low resistivity contrast hydrocarbon productive zones; and
g) Any combination of the above: often a combination of inter-related factors causes the well logging instrument to measure lower resistivity than would ordinarily be expected inside an economically productive formation.

Of all of the factors listed above, probably the most well known cause of low resistivity “pay” (economically productive formation) is the simple combination of thin beds containing highly conductive shales (and their associated bound water), along with thin pay sandstone layers.

From experimental results, corroborated by thermodynamic modeling of downhole fluids at reservoir pressure-temperature conditions, and contrary to conventional perspective it has been have discovered that dense gases having high relative humidity at high pressure/high temperature (HPHT) reservoir conditions (understood for the purposes of this disclosure as a temperature exceeding about 300 degrees F. and pressure exceeding about 10,000 pounds per square inch) may solvate halides, screen ions, and exhibit ionic activity. This results in the fact that dense, wet gases can be potentially electrically conductive. Such is contrary to the basic assumption made in resistivity-based interpretation of whether formations are likely to be economically productive or water productive. Reservoirs with such conditions and being rich in acid gases (e.g., CO₂ and H2S) may manifest low resistivity and little or no contrast between productive reservoirs and water producing formations. However such reservoirs may not have any clay or shale, thin bedding and/or conductive minerals, often associated with traditional LRLC.

Accordingly, there exists a need to identify LRLC productive formations that are not associated with laminated sand and shale sequences.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method according to one aspect for identifying low resistivity low contrast productive subsurface formations penetrated by a wellbore includes obtaining dielectric permittivity measurements of selected formations adjacent at least part of the wellbore. Nuclear magnetic resonance relaxometry measurements are obtained for the selected formations, the relaxometry measurements being calibrated to identify relaxation times corresponding to acid gases in high humidity at elevated pressure and temperature. Zones are then identified for withdrawing formation fluid samples based on the dielectric permittivity and relaxometry measurements.

Other aspects and advantages will be apparent from the description and claims which follow.

### BRIEF DESCRIPTION OF THE DRAWINGS

Certain embodiments are described below with reference to the following figures:

FIG. 1 shows an example of a well site system that may be used to obtain formation fluids samples for formation evaluation during the drilling of a wellbore in accordance with one embodiment of the disclosure;

FIG. 2 shows an example embodiment of obtaining formation fluid samples using a wireline or similarly conveyed sampling instrument; and

FIG. 3 shows an example computer system.

### DETAILED DESCRIPTION

The present description is made with reference to the accompanying drawings, in which example embodiments are shown. However, many different embodiments may be used, and thus the description should not be construed as being limited to the embodiments set forth herein. Rather, these embodiments are provided so that this disclosure will be thorough and complete. Generally, like numbers refer to like elements throughout the present description.

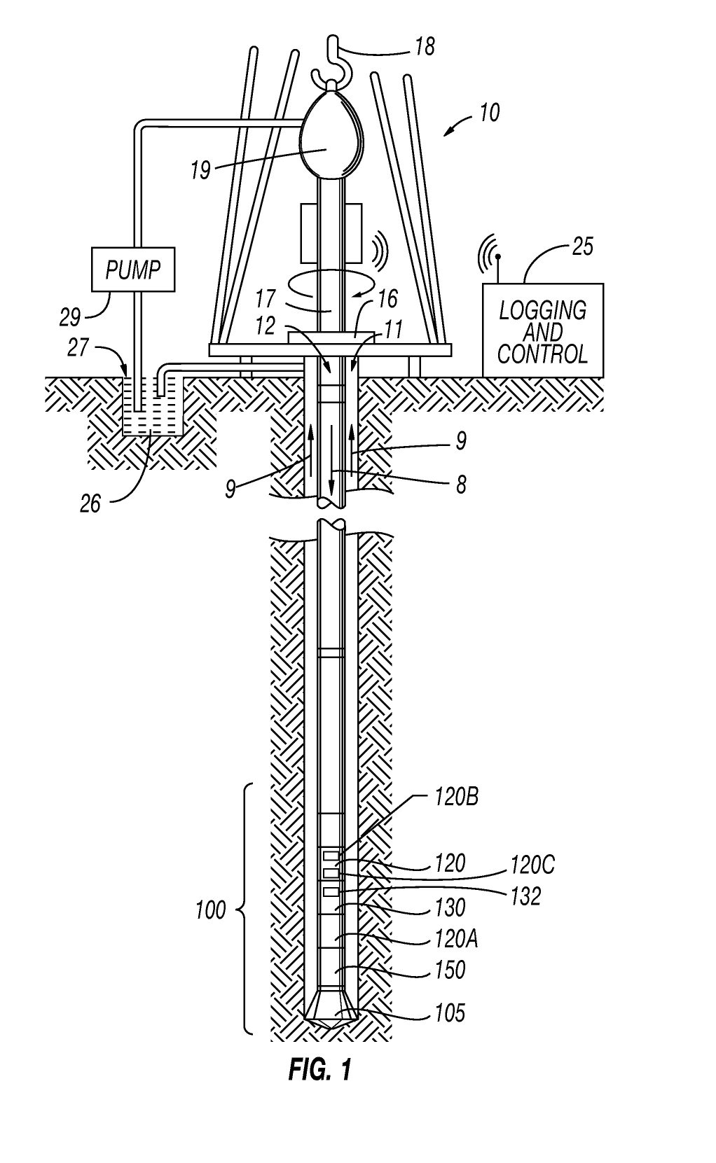

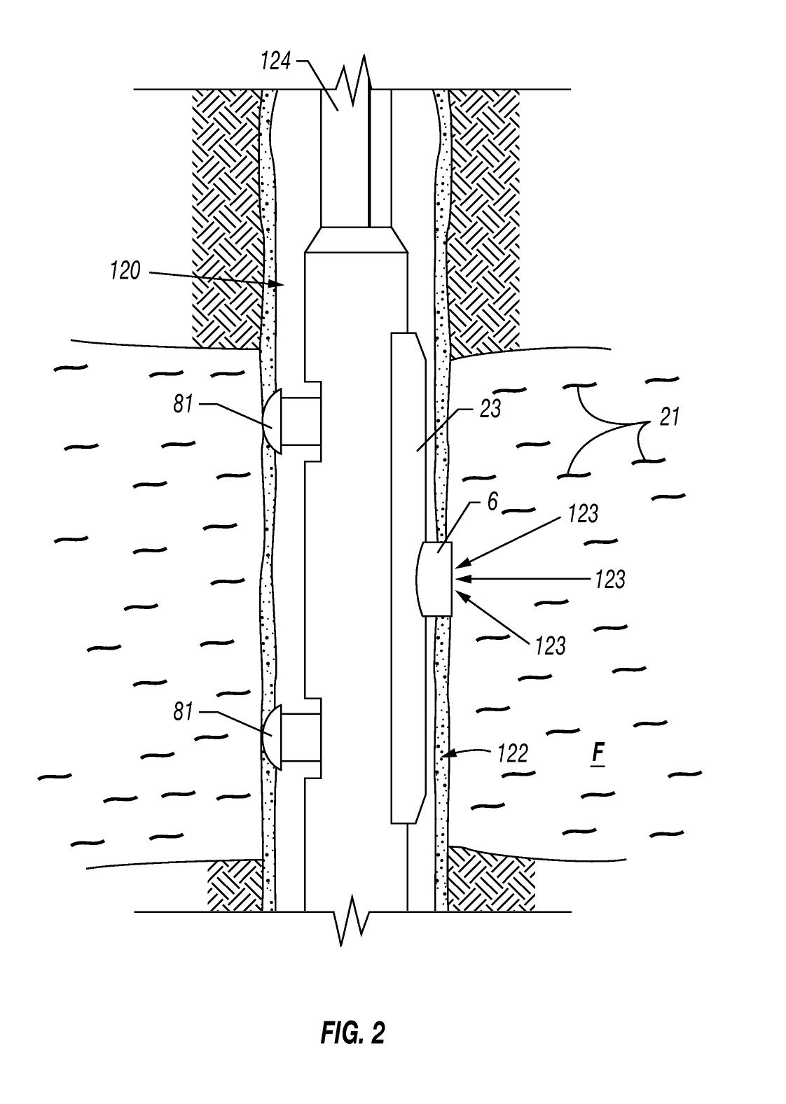

Various examples of methods and apparatus to be explained herein may be implemented in a wellbore fluid sample taking and analysis instrument, or as separate well logging instruments or modules. Such instruments or modules may be conveyed through a wellbore during or after drilling thereof as part of a drill string assembly. Other examples of such instruments may be conveyed into a wellbore using armored electrical cable (wireline), coiled tubing, workover pipe, production tubing or any other conveyance known in the art. Two examples will now be explained with reference to FIGS. 1 and 2.

FIG. 1 illustrates a wellsite system in which the wellbore fluid sample taking instrument can be used. The wellsite can be onshore or offshore. In the example system in FIG. 1, a borehole 11 is formed in subsurface formations by rotary drilling in a manner that is well known. Embodiments of the drilling system can also use various forms of directional drilling equipment known in the art.

A drill string 12 is suspended within the borehole 11 and has a bottom hole assembly 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system (not shown) could be used instead of the kelly 17 and swivel 19.

In the present example, the surface system may further include drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

A bottom hole assembly 100 of the illustrated embodiment may include a logging-while-drilling (LWD) module 120, a measuring-while-drilling (MWD) module 130, a rotary steerable directional drilling system and/or drilling motor 150, and drill bit 105.

The LWD module 120 may be housed in a special type of drill collar, as is known in the art, and can contain one or multiple known types of logging tools. It will also be understood that more than one LWD and/or MWD module can be employed, e.g. as represented at 120A. (References, throughout, to a module at the position of 120 can thus also mean a module at the position of 120A as well.) The LWD module may include capabilities for measuring, processing, and storing information, as well as for communicating with the surface equipment 25. In the presently illustrated embodiment, the LWD 120 module may include a formation dielectric constant measuring instrument, referred to in FIG. 1 as module 120B. The LWD module 120 may also include a nuclear magnetic resonance relaxometry instrument, referred to as module 120C, as will be further explained below.

Like the LWD module 120 (or 120A), the MWD module 130 may also be housed in a special type of drill collar, as is known in the art, and can contain one or more devices for measuring characteristics of the drill string and/or drill bit. The MWD tool 130 further includes an apparatus (not shown) for generating electrical power to the downhole system. This may typically include a mud turbine generator powered by the flow of the drilling fluid, it being understood that other power and/or battery systems may be employed instead of or in addition thereto. In the present example, the MWD module 130 may include one or more of the following types of measuring devices: a weight-on-bit measuring device, a torque measuring device, a vibration measuring device, a shock measuring device, a stick slip measuring device, a direction measuring device, and an inclination measuring device. The MWD module 130 may include a local communication device 132 for telemetry, such as a drilling fluid flow modulator of any type known in the art to communicate measurements made by the MWD module 130 and/or LWD modules 120, 120A to a surface logging and control unit 25. The modules 130, 120, 120A may also include internal memory or other data storage (not shown separately) in which measurements made by the various instruments in the modules 130, 120, 120A may be recorded and communicated to the surface logging and control unit 25 such as by electrical cable when the BHA 100 is withdrawn to the surface from the wellbore 11.

FIG. 2 shows a simplified diagram of a sampling instrument of a type described, for example, in commonly owned U.S. Pat. No. 7,594,541 (also published as U.S. Patent Application Publication No. 2008/0156486), which is incorporated herein by reference in its entirety. The sampling instrument may be used the LWD module 120 or part of an LWD module suite 120A. As shown in FIG. 2, the LWD module 120 (or module suite 120A) may be provided with a probe 6 for establishing fluid communication with a selected formation F and drawing fluid 21 therefrom into internal passages in the LWD module 120, as indicated by arrows 123. The probe 6 may be disposed in a stabilizer blade 23 of the LWD module 120 or module suite 120A and may be extended therefrom to engage the borehole wall 122. The stabilizer blade 23 may include one or more blades that are in contact with the borehole wall 122. Fluid drawn into the LWD tool 120 from the selected formation F using the probe 6 may be measured to determine, for example, pretest and/or pressure parameters.

Additionally, the LWD module 120 may be provided with devices, such as sample chambers (not shown in FIG. 2), for collecting fluid samples for retrieval at the surface. Backup pistons 81 may also be provided to assist in applying force to push the LWD module 120 and/or probe 6 against the borehole wall 122. It should be clearly understood that the example system shown in FIG. 2 may also be conveyed by means other than a drill string, as explained above, for example, by conveyance at the end of an armored electrical cable 124 (e.g., wireline).

In the present example, measurements made by the dielectric constant module (120B in FIG. 1) and/or the nuclear magnetic resonance relaxometry module (120C in FIG. 1) may be used to identify formations that may have low resistivity low contrast (LRLC), yet economically productive fluid content that might otherwise be unresolved by conventional and/or multiaxial resistivity measurements.

Dielectric permittivity measurements may be able to assess pore and clay bound water in the formation and distinguish it from total porosity less hydrocarbon occupied pore volume. This is because water and hydrocarbons/gases have different dielectric permittivities, even at high pressure-high temperature (HPHT), though the difference may be smaller due to the large volume fraction of water dissolved in dense or supercritical gases. As stated above, for the purposes of this disclosure, high pressure and high temperature conditions (HPHT) is understood to mean reservoir conditions at a temperature of about 300 degrees F. in temperature and a pressure of about 10,000 psi or higher. By way of example, conditions up to 600 degrees F. and 40,000 psi may be considered HPHT conditions as well, although these example values should not be construed as necessarily implying upper limits for HPHT. Further, in some instances, HP (high pressure) may be considered as beginning at about 5,000 psi. Appended are data points suggestive of using a HPHT dielectric tool in such environments to assist in identifying LRLC hydrocarbon productive formations. One example of a dielectric module and/or instrument that may be used in some examples is sold under the trademark DIELECTRIC SCANNER, which is a trademark of Schlumberger Technology Corporation, Sugar Land, Tex. Table 1 below shows a comparison of common materials' dielectric permittivity.

TABLE 1

| Material | Permittivity ε′ |
|---|---|
| Sandstone | 4.65 |
| Dolomite | 6.8 |
| Limestone | 7.4-9.2 |
| Pyrite | 10.9 |
| Graphite | 12-15 |
| Oil | 2.0-2.4 |
| Shale | 5-25 |
| Fresh water at 75° F. | 78.3 |
| CO₂ | 1.6 |
| H₂S | 5.8 |
| Methane | 1.7 |

Dielectric permittivity measurements can distinguish water, as both pore space-bound and clay-bound water, and free (mobile) water in the total formation porosity less hydrocarbon occupied pore volume. In an example screening procedure, the following steps may be performed:
1) Calculate S_{w-total} (total water saturation) using total porosity. By way total porosity in this example, may be determined using petrophysics interpretation tools, such as ELAN, a trademark of Schlumberger Technology Corporation of Sugar Land, Tex.;
2) Compare the determined total porosity and corresponding water saturation with S_{w-total}, which may be determined in the present example from neutron and density porosity and resistivity;
3) Estimate flushed-zone water resistivity (Rxo), that is, the water resistivity in the zone adjacent the wellbore in which the liquid phase of the drilling fluid has substantially displaced the connate or native formation water in the formation pore spaces;
4) Estimate R_{w} (resistivity of the native formation water) and R_{cbw} (resistivity of bound water in or associated with clay minerals) for shale zones adjacent to the possible productive zones so identified; and
5) using the dielectric measurements, determine the dielectric permittivity ∈′ for water, which may be different from gases.

As can be appreciated, the permittivity ∈′ of water is very different from that of gases. At HPHT conditions (e.g., 300 degrees F. or higher, 10,000 psi or higher), ∈′ of water will typically decrease and the ∈′ of gases (with dissolved water) will typically increase. However, hydrocarbon bearing zones and water productive zones may still be distinguished based on permittivity.

As described in the article, Boyd et al, “The Lowdown on Low-Resistivity Pay,” Schlumberger Oilfield Review, vol. 7, issue 3, pp. 4-18 (1995), a more difficult problem for well log interpreters than thin beds is the existence of small grain size rock minerals in the formation (e.g., F in FIG. 2) which contributes to high irreducible water saturation. A better understanding of the grain size and pore throats are detailed in the technical article Sondergeld et al., “Micro-Structural Studies of Gas Shales,” SPE 131771 presented during the Unconventional Gas conference, February 23^{rd} to 25^{th} Pittsburgh, Pa., 2010, hereby incorporated by reference in its entirety. As stated in the Sondergeld publication, shale and clays have been found to have grain sizes of less than approximately 39 μm. It has been found that grain sizes of smaller than about 1 to 5 microns in formation minerals may result in the formation having LRLC characteristics. This is due, in part, to the increased presence of capillary bound water in such formations, for example sandstone, especially where clay and/or ash shards or other conducting minerals are also present.

A possible solution may be to use a nuclear magnetic resonance (NMR) relaxometry instrument or module (120B in FIG. 1), such as one sold under the trademark Combined Magnetic Resonance (CMR), a trademark of Schlumberger Technology Corporation of Sugar Land, Tex. The NMR instrument or module of may be capable of measuring irreducible water saturation, lithology independent porosity, and average pore size by measuring nuclear magnetic resonance spin echo amplitudes. Because NMR spin echo amplitude increases with the number of mobile protons, which itself increases with fluid content, the initial spin echo amplitude is proportional to the fluid content of the formation. How quickly the spin echo amplitudes decay from the initial spin echo amplitude is related to the NMR relaxation time. NMR relaxation time and/or distribution of such relaxation times can provide information about the pore size, and to some extent the amount and type of oil that may be present in the pore spaces of the formation (F in FIG. 2). An NMR log may display distributions of transverse (or longitudinal) relaxation (i.e. T₂ and/or T₁) times with respect to depth. Relaxation time distribution may correspond to pore size distributions.

As can be appreciated, the area under a spectrum (curve) of relaxation times (i.e., a graph of amplitude with respect to values of relaxation time) may be referred to as the NMR porosity, and is generally lithology independent (unlike density and/or neutron and/or acoustic travel time determined porosity). In one example embodiment, an NMR instrument may have a diameter of investigation of about 1 inch, and a vertical (axial) resolution of about 6 inches. In the case of HPHT wet, dense gases (especially those rich in acid gases) with large volume fraction of dissolved water, and thus available mobile protons, the relaxation time (e.g., T₂) distribution may be different than that of a dry gas. Thus, as NMR instrument used to perform aspects to perform aspects of the presently disclosed techniques may, by way of example, include the CMR instrument or another NMR instrument, such as one sold under the trademark MR SCANNER, by Schlumberger Technology Corporation of Sugar Land, Tex., trained or otherwise calibrated to such fluids to provide a robust solution in such LRLC productive formations, i.e., to help distinguish between LRLC formations that are economically productive and those that are not.

An NMR measuring instruments may be calibrated for such a purpose, for example, by filling sample formations having known porosity and porosity distribution using gas having selected concentrations of water vapor, methane, CO₂ and H₂S. Resulting relaxation time distributions (T₂ or T₁) determined as ordinarily performed using such instruments or modules may be stored in a look up table or calibrated to a best fit curve with respect to acid gas/methane saturation and measured electrical resistivity. Hydrocarbon productive zones, in some examples, may not manifest lower electrical resistivity due to the presence of highly sorted, fine grain structure and/or coating of grains with water adsorbing minerals, such as ash, i.e., See the above-referenced Sondergeld publication. Such minerals may be identifiable using nuclear magnetic resonance measurements and mineralogy of thin sections from core samples.

In operation of an instrument string, such as shown in FIG. 1, when low resistivity zones relatively free of clay minerals (e.g., as indicated by a low natural gamma ray measurement) and indicative of permeability (e.g., differences between resistivity measurements made to different lateral depths of investigation in the formation) are encountered, the dielectric measurements may be used to evaluate whether the formation fluid is primarily water or another fluid. NMR instrument or module measurements, calibrated as explained above, may be used to determine whether the formation fluid is hydrocarbon gas and/or acid gas in high humidity conditions. Such determinations may be used to identify formations that are likely to be successfully tested by withdrawing fluid samples such as by using the formation sample-taking instrument explained above with reference to FIG. 2.

A method according to the examples explained herein may enable identification of zones that are suitable for fluid sample testing, and may reduce the number of formation zones that are bypassed for such testing on the basis of conventional resistivity analysis.

In one example, the formation testing instrument shown in FIG. 2 may be one sold under the trademark MDT, which is a trademark of Schlumberger Technology Corporation, Sugar Land, Tex. The MDT instrument may include a module (conveyed by any means including in the drill string as explained with reference to FIG. 1) that can perform NMR relaxometry measurements on fluid samples withdrawn from the subsurface formations, e.g., as explained with reference to FIG. 2. T₂ (or T₁) times may be determined for the fluids withdrawn from the formation, and these relaxation times may be used to enable determination of whether the tested formation is likely to produce water or other fluids (e.g., methane and/or acid gases).

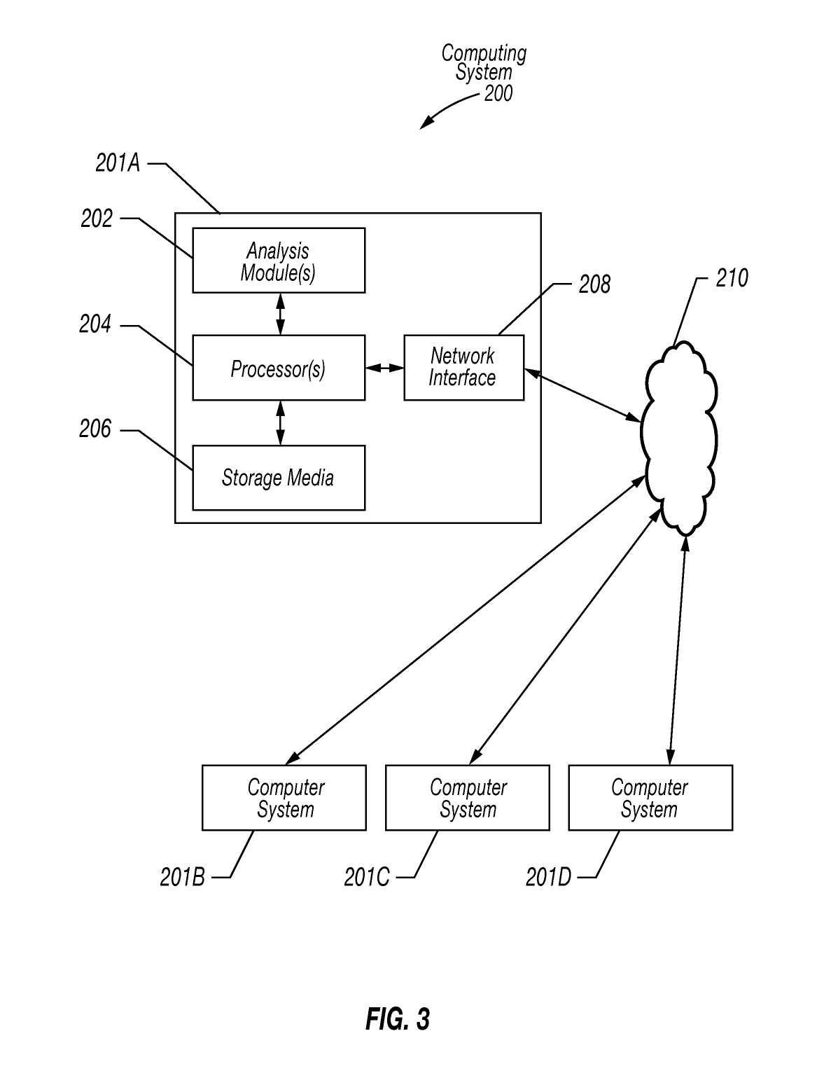

FIG. 3 shows an example computing system 200 in accordance with some embodiments. The computing system 200 can be an individual computer system 201A or an arrangement of distributed computer systems. The computer system 201A may include one or more analysis modules 202 that are configured to perform various tasks according to some embodiments, such as the tasks described hereinabove. To perform these various tasks, the analysis module 202 may execute independently, or in coordination with, one or more processors 204, which may be connected to one or more storage media 206. The processor(s) 204 may also be connected to a network interface 208 to allow the computer system 201A to communicate over a data network 210 with one or more additional computer systems and/or computing systems, such as 201B, 201C, and/or 201D (note that computer systems 201B, 201C and/or 201D may or may not share the same architecture as computer system 201A, and may be located in different physical locations, e.g. computer systems 201A and 201B may be on a ship or platform on the ocean, while in communication with one or more computer systems such as 201C and/or 201D that are located in one or more data centers on shore, other ships, and/or located in varying countries on different continents).

A processor can include a microprocessor, microcontroller, processor module or subsystem, programmable integrated circuit, programmable gate array, application-specific integrated circuit (ASIC), a system-on-a-chip (SoC) processor, or another suitable type of control or computing device.

The storage media 206 can be implemented as one or more computer-readable or machine-readable storage media. Note that while in the example of FIG. 3 the storage media 206 is depicted as within computer system 201A, in some embodiments, storage media 206 may be distributed within and/or across multiple internal and/or external enclosures of computing system 201A and/or additional computing systems. Storage media 206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 200 is only one example of a computing system, and that computing system 200 may have more or fewer components than shown, may combine additional components not depicted in the exemplary embodiment of FIG. 3, and/or computing system 200 may have a different configuration or arrangement of the components depicted in FIG. 3. The various components shown in FIG. 3 may be implemented in hardware, software, or a combination of both hardware and software, including one or more signal processing and/or application specific integrated circuits.

Further, the steps in the various processing and evaluation methods and steps described above may be implemented by running one or more functional modules in an information processing apparatus such as general purpose processors or application specific chips, such as ASICs, FPGAs, SoCs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for identifying low resistivity low contrast hydrocarbon productive subsurface formations penetrated by a wellbore, comprising:
obtaining dielectric permittivity measurements of selected formations adjacent at least part of the wellbore;
obtaining nuclear magnetic resonance relaxometry measurements of the selected formations, the relaxometry measurements calibrated to identify relaxation times corresponding to acid gases having predetermined humidity at predetermined pressure and predetermined temperature;
in a computer, identifying at least one zone in the selected formations for withdrawing formation fluid samples based on the dielectric permittivity measurements and relaxometry measurements, whereby the dielectric permittivity measurements and relaxometry measurements are used to confirm presence of hydrocarbons in the identified zones.

2. The method of claim 1, wherein water, acid gases and inorganic ions dissolved in hydrocarbon vapors lower an electrical resistivity thereof so as to make hydrocarbon productive formations substantially indistinguishable from water productive formations based only on measurements of electrical resistivity and porosity of the formations.

3. The method of claim 1, comprising, when hydrocarbon productive zones do not manifest lower electrical resistivity due to presence of highly sorted fine grain structure and/or coating of grains with water adsorbing minerals comprising ash, using nuclear magnetic resonance measurements and mineralogy of thin sections from core samples to identify such minerals so as to make the hydrocarbon productive formations distinguishable from water productive formations.

4. The method of claim 1, wherein a mineral composition independent porosity is determined using the relaxometry measurements.

5. The method of claim 4 wherein the mineral composition independent porosity is determined using a distribution of relaxation times.

6. The method of claim 1 wherein the relaxometry measurements comprise at least one of transverse or longitudinal relaxation times.

7. The method of claim 1 wherein at least one of the dielectric measurements and the relaxometry measurements are obtained by moving an instrument through the wellbore disposed in a drill string.

8. The method of claim 1 wherein at least one of the dielectric measurements and the relaxometry measurements are obtained by moving an instrument through the wellbore at an end of an armored electrical cable.

9. The method of claim 1 further comprising withdrawing a sample of fluid in the at least one zone using a probe urged into contact with a formation penetrated by the wellbore.

10. A method for identifying low resistivity low contrast hydrocarbon productive subsurface formations penetrated by a wellbore, comprising:
moving a well logging instrument along the wellbore, the instrument comprising at least a dielectric permittivity sensor and a nuclear magnetic resonance relaxometry sensor;
measuring dielectric permittivity of selected formations along at least part of the wellbore using the dielectric permittivity sensor;
measuring nuclear magnetic resonance relaxation times of the selected formations using the nuclear magnetic resonance relaxometry sensor, the relaxation time measurements being calibrated to identify relaxation times corresponding to acid gases having predetermined humidity at predetermined pressure and predetermined temperature;
in a computer, identifying at least one zone for withdrawing formation fluid samples based on the dielectric permittivity measurements and relaxation time measurements, whereby the dielectric permittivity measurements and relaxation time measurements are used to confirm presence of hydrocarbons in the identified zones.

11. The method of claim 10 wherein water, acid gases and inorganic ions dissolved in hydrocarbon vapors lower an electrical resistivity thereof so as to make hydrocarbon productive formations substantially indistinguishable from water productive formations based only on measurements of electrical resistivity and porosity of the formations.

12. The method of claim 10 wherein hydrocarbon productive zones do not manifest lower electrical resistivity due to presence of highly sorted fine grain structure and/or coating of grains with water adsorbing minerals comprising ash, and the method comprises using nuclear magnetic resonance measurements and mineralogy of thin sections from core samples to identify such minerals so as to make the hydrocarbon productive formations distinguishable from water productive formations

13. The method of claim 10 wherein a mineral composition independent porosity is determined using the relaxometry measurements.

14. The method of claim 13 wherein the mineral composition independent porosity is determined using a distribution of relaxation times.

15. The method of claim 10 wherein the relaxometry measurements comprise at least one of transverse and longitudinal relaxation times.

16. The method of claim 10 wherein at least one of the dielectric measurements and the relaxometry measurements are obtained by moving an instrument through the wellbore disposed in a drill string.

17. The method of claim 10 wherein at least one of the dielectric measurements and the relaxometry measurements are obtained by moving an instrument through the wellbore at an end of an armored electrical cable.

18. The method of claim 10 further comprising withdrawing a sample of fluid in the at least one zone using a probe urged into contact with a formation penetrated by the wellbore.
